(19) United States
(12) Patent Application Publication
(10) Pub. No.: US 2025/0049260 A1
(43) Pub. Date: Feb. 13, 2025

(54) ROTARY PIZZA OVEN

(71) Applicant: TURPONE GROUP, Montreal (CA)

(72) Inventor: FAN JUNYING, Shenzhen (CN)

(21) Appl. No.: 18/232,891

(22) Filed: Aug. 11, 2023

(51) Int. Cl. A47J 37/06; A47J 37/04

(52) U.S. Cl. CPC A47J 37/0658; A47J 37/043; A47J 37/0647

(57) ABSTRACT

A pizza oven comprises an upper casing and an enclosure positioned beneath the casing. The casing comprises a shell structure mounted to a bottom plate defining a chamber therein and an opening for accessing the chamber. The enclosure is mounted to the bottom plate and comprises a control panel beneath the opening. A rotatable tray is rotatably mounted within the chamber. The underside of the tray comprises a central seat rotatably positioned within a bottom plate opening. An actuator is mounted within the enclosure and comprises an upwardly extending drive shaft positioned beneath the seat and operatively communicating therewith for imparting a rotational movement to the tray. A heating assembly is mounted within the enclosure and comprises a heating part extending into the chamber behind the tray for providing heat. Controls are provided on the control panel for controlling the actuator and the heating assembly.

### TECHNICAL FIELD

The present disclosure generally relates to a pizza over. More particularly but not exclusively, the present disclosure relates to a rotary pizza oven. Still more particularly but still not exclusively, the present disclosure relates to a portable pizza oven.

### BACKGROUND

Rotary and portable pizza ovens are well known. Many such ovens have a cross bar within the baking chamber on which the baking tray sits for rotation. The cross bar spans the full size of the tray. These cross bars cool down faster than the tray and this differential may cause cracking of the tray. The weight distribution of such ovens is usually lobsided with controls and motors in the rear and the opening for viewing the pizza in the front

### OBJECTS

An object of the present disclosure is to provide a rotary pizza oven.

An object of the present disclosure is to provide a portable pizza oven.

### SUMMARY

In accordance with an aspect of the present disclosure, there is provided a pizza oven comprising: a housing defining front, rear, top and bottom sides thereof and comprising: an upper casing comprising a shell structure mounted to a bottom plate and defining an inner chamber therein and an opening at the front side providing access to the inner chamber; and an enclosure positioned beneath the casing and mounted to the bottom plate at the bottom side and comprising a control panel at the front end beneath the front opening; a rotatable tray rotatably mounted within the chamber for baking a pizza thereon, the rotatable tray defining a top side for receiving the pizza and an underside comprising a central seat rotatably positioned within an opening in the bottom plate; an actuator mounted within the enclosure and comprising an upwardly extending drive shaft positioned beneath the seat and operatively communicating therewith for imparting a rotational movement to the rotatable tray; a heating assembly mounted within the enclosure and comprising a heating part thereof extending into the chamber behind the rotatable tray for providing heat; and controls provided on the control panel in operative communication with the actuator and the heating assembly for selective control thereof.

In an embodiment, the pizza over further comprises support rollers protruding from the bottom plate to be engaged by the underside of the rotatable plate for stability thereof.

In an embodiment, the housing further comprises an gas intake at the rear side in fluid communication with the heat assembly for providing gas thereto.

In an embodiment, the enclosure is a longitudinal structure positioned along a central part of the bottom plate.

In an embodiment, the rotatable tray and the seat are a single molded piece.

In an embodiment, the actuator comprises a motor, the drive shaft upwardly extending from the motor.

In an embodiment, the chamber defines a front chamber part and a rear chamber part partitioned by a fire plate therebetween, wherein the rotatable plate is positioned within the front chamber part and the heating part is positioned within the rear chamber part.

In an embodiment, the heating part comprises a horizontal burner, a tube extends from the horizontal burner into the enclosure.

In an embodiment, the shell structure comprises spaced apart outer and inner shells defining an insulation space therebetween.

In an embodiment, the controls provide for controlling heat and rotation.

In an embodiment, the pizza oven further comprises support legs mounted to the housing at the bottom side.

In an embodiment, the pizza oven comprises an upper casing and an enclosure positioned beneath the casing. The casing comprises a shell structure mounted to a bottom plate defining a chamber therein and an opening for accessing the chamber. The enclosure is mounted to the bottom plate and comprises a control panel beneath the opening. A rotatable tray is rotatably mounted within the chamber. The underside of the tray comprises a central seat rotatably positioned within a bottom plate opening. An actuator is mounted within the enclosure and comprises an upwardly extending drive shaft positioned beneath the seat and operatively communicating therewith for imparting a rotational movement to the tray. A heating assembly is mounted within the enclosure and comprises a heating part extending into the chamber behind the tray for providing heat. Controls are provided on the control panel for controlling the actuator and the heating assembly.

In accordance with an aspect of the present disclosure, there is provided a rotary pizza oven comprising a shell, a bottom plate, a motor, a driving shaft, a baking tray, at least three roller groups, a device box, a gas valve, an igniter, an ignition needle, an induction needle, a straight tube type burner and a battery box, the casing is provided with a front opening and a lower opening, the bottom plate is provided with a shaft sleeve, and the lower surface of the baking tray is provided with a circular shaft seat; the lower opening end of the shell and the bottom plate are fixed to form a cavity with a front opening, the front part of the cavity is a baking cavity, the rear part of the cavity is a combustion cavity, the roller groups are arranged on the bottom plate and are uniformly distributed around the rotating sleeve, the circular shaft seat is in rotating fit with the shaft sleeve and can be detached, and the rollers of the roller groups are matched with the baking tray; the straight tube type burner is arranged in the combustion chamber; the upper open end of the device box is connected with the bottom plate, the motor, the gas valve and the igniter are arranged in the device box, the driving shaft is fixed with the shaft of the motor, and the driving shaft is connected with the circular shaft seat and can be detachably matched with the circular shaft seat.

In an embodiment, the shell comprises an inner container and a shell, the lower opening end of the inner container is fixed with the bottom plate, the shell wraps the inner container and extends to the lower portion of the bottom plate, and the shell and the inner container form a heat insulation cavity.

In an embodiment, the inner container comprises a container body part and a container rear end plate, the outer shell comprises a shell part and a shell rear end plate, the straight tube type burner, the ignition needle and the induction needle are fixed on the liner rear end plate, and the air inlet pipe of the straight tube type burner is fixed with the device box.

In an embodiment, the pizza oven also comprises a seat board and a frame-shaped frame with an upper opening, the motor is fixed on a transverse frame plate of the frame, a shaft of the motor is in running fit with a shaft hole on the transverse frame plate, the driving shaft is in running fit with a rotating shaft hole on the seat plate, and the seat plate is fixed with the upper end of the device box.

In an embodiment, the epaxial external screw thread connecting portion that is equipped with of motor, the lower extreme of drive shaft is equipped with the internal thread hole, and motor anticlockwise rotation.

In an embodiment, the driving shaft is in a polygonal shape, the circular shaft seat is provided with a polygonal connecting hole, and the driving shaft is detachably matched with the polygonal connecting hole.

In an embodiment, a heat conduction hole is formed in the partition plate between the baking cavity and the combustion cavity of the cavity, and a heat conduction gap is formed between the upper end of the partition plate and the top plate of the cavity. In an embodiment, the heat conduction hole is formed in the partition plate between the baking cavity and the combustion cavity of the cavity, and a heat conduction gap is formed between the upper end of the partition plate and the top plate of the cavity.

In an embodiment, the battery box comprises a box body with a lower opening, a box cover and a battery arranged in the box body, the bottom plate of the device box is provided with a mounting hole, the box body is inserted into the mounting hole and fixed with the bottom plate of the device box, and the box cover is detachably matched with the box body.

Other objects, advantages and features of the present disclosure will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a front view of the rotary pizza oven in accordance with a non-limiting illustrative embodiment of the present disclosure;

FIG. 2 is a sectional view of FIG. 1 taken along line 2-2 thereof;

FIG. 3 is an exploded view of the rotary pizza oven of FIG. 1 in accordance with a non-limiting illustrative embodiment of the present disclosure;

FIG. 4 is another exploded view of the rotary pizza oven of FIG. 1 in accordance with a non-limiting illustrative embodiment of the present disclosure;

FIG. 5 is a further exploded view of the rotary pizza oven of FIG. 1 in accordance with a non-limiting illustrative embodiment of the present disclosure;

FIG. 6 is yet another exploded view of the rotary pizza oven of FIG. 1 in accordance with a non-limiting illustrative embodiment of the present disclosure;

FIG. 7 is yet a further exploded view of the rotary pizza oven of FIG. 1 in accordance with a non-limiting illustrative embodiment of the present disclosure;

FIG. 8 is still another exploded view of the rotary pizza oven of FIG. 1 in accordance with a non-limiting illustrative embodiment of the present disclosure;

FIG. 9 is a perspective view of the rotary pizza oven in accordance with another non-limiting illustrative embodiment of the present disclosure;

FIG. 10 is a top perspective view of the rotary pizza oven of FIG. 9;

FIG. 11 is front view of the rotary pizza oven of FIG. 9;

FIG. 12 is a partial sectional view of the rotary pizza oven taken along line 12-12 of FIG. 11;

FIG. 13 is partial sectional view of the rotary pizza oven taken along line 13-13 of FIG. 9;

FIG. 14 is a partially exploded view of the rotary pizza oven of FIG. 9 in accordance with a non-limiting illustrative embodiment of the present disclosure;

FIG. 15 is another exploded view of the rotary pizza oven of FIG. 9 in accordance with a non-limiting illustrative embodiment of the present disclosure;

FIG. 16 a fully exploded view of the rotary pizza oven of FIG. 9 in accordance with a non-limiting illustrative embodiment of the present disclosure; and

FIG. 17 is an enlarged partial view and exploded view of the actuator and tray of the rotary pizza oven of FIG. 9 in accordance with a non-limiting illustrative embodiment of the present disclosure.

### DETAILED DESCRIPTION OF ILLUSTRATIVE EMBODIMENTS

Generally stated and in accordance with an aspect of the present disclosure, there is provided a pizza oven comprising a housing comprising an upper casing and an enclosure positioned beneath the casing. The casing comprises a shell structure mounted to a bottom plate and defines an inner chamber and an opening for accessing the inner chamber. The enclosure is mounted to the bottom plate and comprises a control panel beneath the front opening. A rotatable tray is rotatably mounted within the chamber for baking a pizza thereon. The rotatable tray defines a top side for receiving the pizza and an underside comprising a central seat rotatably positioned within an opening in the bottom plate. An actuator is mounted within the enclosure and comprises an upwardly extending drive shaft positioned beneath the seat and operatively communicating therewith for imparting a rotational movement to the rotatable tray. A heating assembly is mounted within the enclosure and comprises a heating part extending into the chamber behind the rotatable tray for providing heat. Controls are provided on the control panel for selective control thereof of the actuator and the heating assembly.

In an embodiment, the present disclosure provides a rotary portable pizza oven with a casing defining a chamber and a front opening for accessing the chamber. A rotatable plate or tray is positioned at a front part of the chamber for placing the pizza thereon. A heating assembly is positioned in the rear part of the chamber. The front and rear parts are separated by a partition plate allowing for heat conduction. An enclosure is positioned beneath the casing and encloses all the mechanical components therein as will be described further below. The enclosure is longitudinal and positioned along a center line of the casing providing a substantially constant center of gravity along the longitudinal center line of the casing and thus along the longitudinal center line of the pizza oven as will be further discussed. The controls for gas and rotation are positioned at the front of casing where the opening is and where the user can view baking of the pizza. As such, the oven with frontal controls allows to control the temperature as well as stopping and starting rotation while directly watching the baking pizza and as well as height of the flames. Placing the components of the oven in an enclosure beneath the casing allows for positioning the gas and rotation controls at the front of the oven next to the opening. The components are safely positioned and enclosed beneath the casing providing a unit with centered weight making it more compact and portable as it is safer and easier to handle. Using a motor directly beneath and connected to the tray for rotation thereof via a drive shaft together with rollers protruding from the base plate of the chamber for supporting the rotating tray thereon provides for a lighter and more efficient over. Indeed, the actuator is positioned directly beneath the rotating tray, the drive shaft upwardly extends and engages (directly or via other components therebetween) the center of the rotating tray. Thus there is a straight vertical alignment between the center of the tray, the drive shaft and the actuator. The rotation speed is purely influenced by the motor sequence (setting of the motor). There are no additional tray supports (longitudinal rods etc.) other than small rollers protruding slightly from the base plate and this in this way there is no temperature differential between cross bar supports and the tray in addition to reducing the weight of the oven.

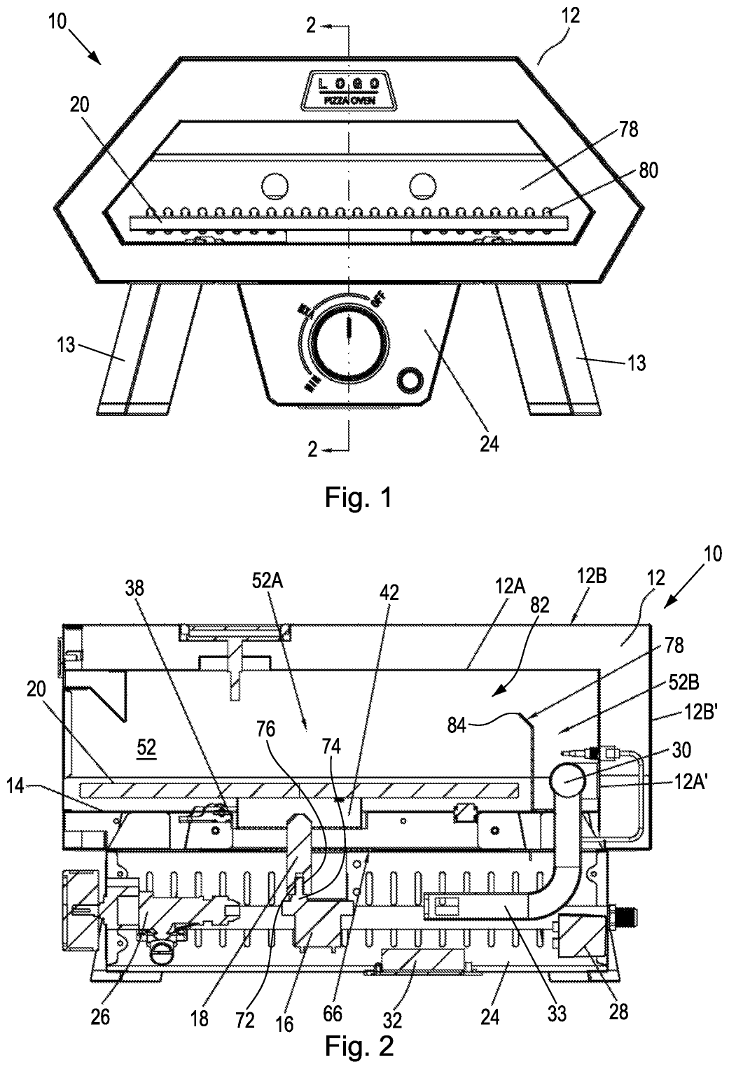

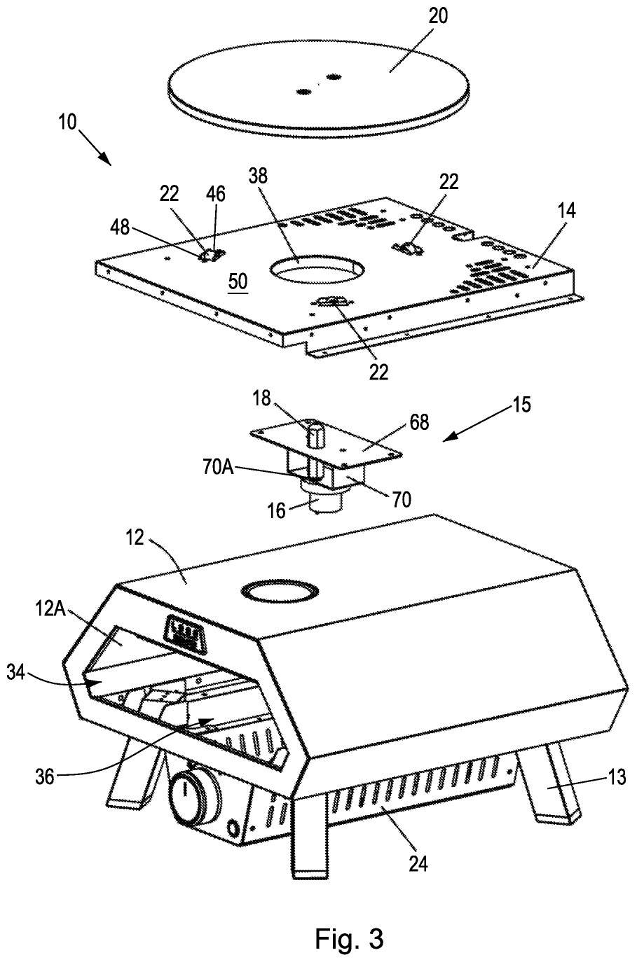

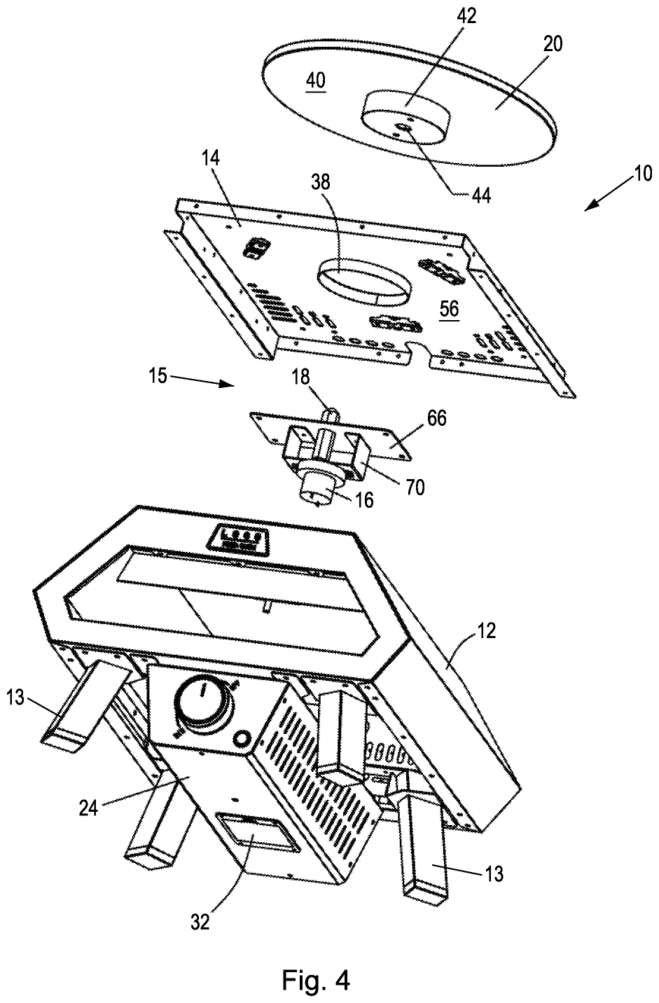

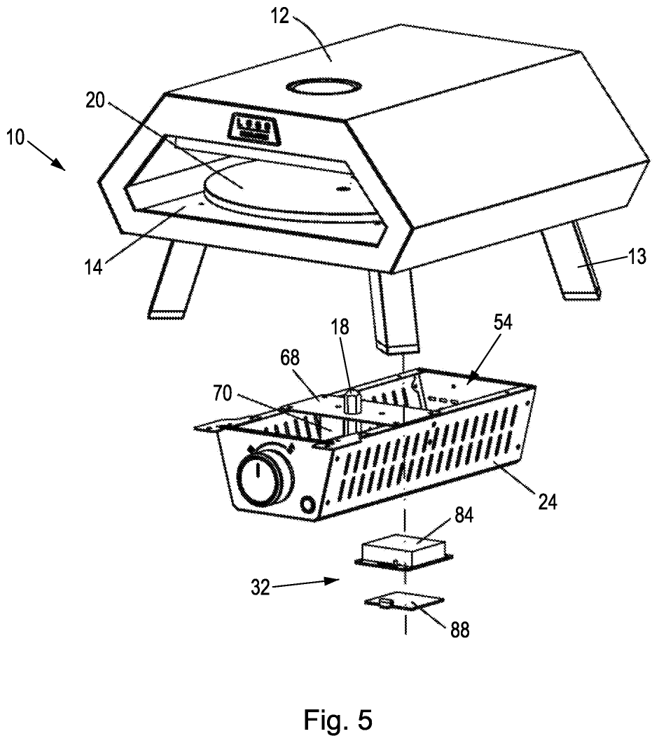

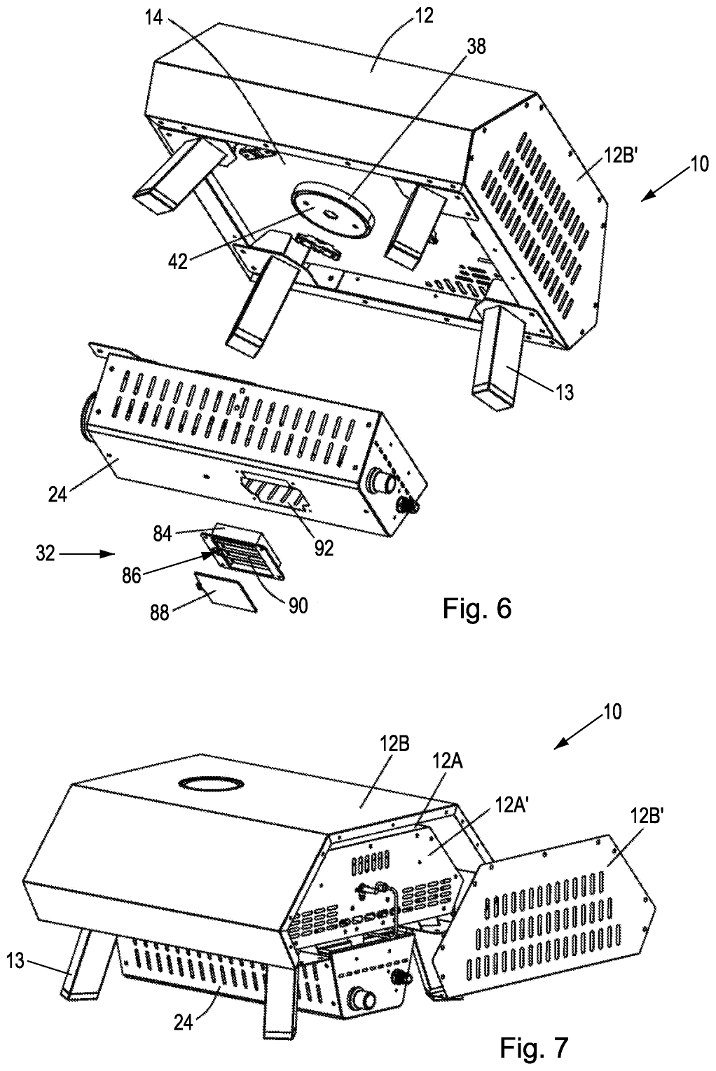

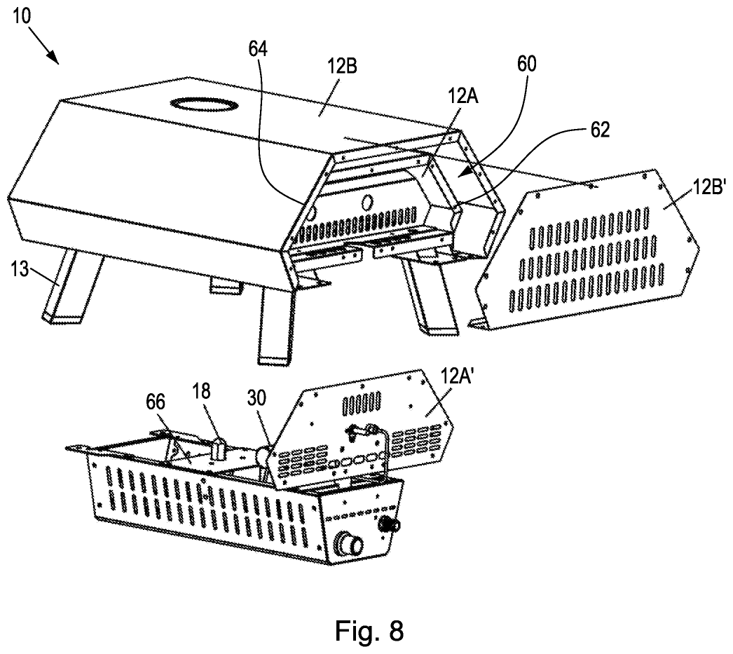

With reference to FIGS. 1 to 8, the rotary pizza over 10 in accordance with a non-restrictive illustrative embodiment of the present disclosure will now be described by way of non-limiting examples.

The rotary pizza oven 10 comprises a casing 12 including support legs 13, a bottom plate 14, an actuator 15 including a motor 16 and a driving shaft 18, a baking tray 20, rollers 22, an enclosure or device box 24, a gas valve 26, an igniter 28, a straight tube type burner 30 and a battery box 32.

The casing 12 is provided with a front opening 34 and a lower opening 36. The bottom plate 14 is provided with a shaft sleeve 38. The undersurface 40 of the baking tray 20 is provided with a circular shaft seat 42. The circular shaft seat 42 defines an aperture 44. Each roller 22 comprises a roller shaft carrying a wheel. The roller shaft is fixed to the bottom plate 14 and the wheel 46 protrudes via hole 48 on the upper surface 50 of the bottom plate 14.

The lower opening end 36 of the casing 12 and the bottom plate 14 are connected to form a chamber or cavity 52 accessible via the front opening 34. The front part of cavity 52 is a baking chamber or cavity part 52A and the rear part of cavity 52 is a combustion chamber or cavity part 52B.

The baking tray 20 is positioned in the front baking chamber part 52A and is uniformly distributed around the rotating sleeve 38. The circular shaft seat 42 is rotatably and removably fitted through the shaft sleeve 38. The drive shaft 18 operationally engages the shaft 42 via the aperture 44. The motor 16 causes the drive shaft 18 to rotate about its vertical axis thereby rotating the shaft seat 42 along with the baking tray 20. During rotation, the undersurface 40 of the baking tray 20 engages the rollers 22 and is thus maintained in a constant plane as the rollers 22 prevent the tray 20 from inclining. In this way, the maximum output power of the motor 16 is ensured.

The straight tube type burner 30 is arranged in the rear combustion chamber part 52B. The top open end 54 of the device box 24 is connected to the underside 56 of the bottom plate 14. The motor 16, the gas valve 26 and igniter 28 are positioned within the device box 24.

The shell casing 12 comprises an inner liner 12A and an outer shell 12B. The bottom open end 58 of the inner liner 12A is fixed to the top surface 50 of the bottom plate 14. The shell 12B envelops the inner liner 12A and extends and connects to the underside 56 the bottom plate 14. The outer shell 12B and the inner liner 12A are spaced apart forming a cavity 60 therebetween. Cavity 60 is a heat insulation cavity which prevents the outer shell 12B from heating to a degree where a user may burn their hands when touching the outer shell 12B.

As shown in FIGS. 2, 7 and 8, the open rear end of the inner liner 12A is closed by an inner liner backing plate 12A′ mounted to the rear end edge 62 of the inner liner 12A. The open rear end of outer shell 12B is closed by an outer shell backing plate 12B′ mounted to the rear end edge 64 of outer shell 12B.

The straight tube type burner 30, the ignition needle 66 and the induction needle are fixed to the inner liner backing plate 12A′. The air inlet pipe 33 of the straight tube type burner 30 is fixed within the device box 24

The actuator 15 comprises a longitudinal seat plate 68 mounted to a frame 70 defining an upper opening. The motor 16 is positioned on a transverse frame plate 70A of the frame 70. The drive shaft 18 extends from the of the motor 16 rotatably through the transverse frame plate 70A via a shaft hole defined thereby. The drive shaft 18 is rotatably positioned through the seat plate 68 via a shaft hole defined thereby. The seat plate 68 is fixed to the open upper end 54 of the device box 24.

With particular reference to FIG. 2, an external thread connecting part 72 is arranged on the shaft 74 of the motor 16. An internal thread hole 76 is formed in the lower end of the driving shaft 18. The motor 16 rotates anticlockwise to prevent the shaft 74 of the motor 16 from being separated from the driving shaft 18. The shaft 74 of the motor 16 can also be fixedly connected with the driving shaft 18 by screws. The driving shaft 18 is polygonal, the circular shaft seat 42 is provided with polygonal connecting holes, and the driving shaft 18 is detachably matched with the polygonal connecting holes.

A partition plate 78 is positioned between the front baking chamber part 52A and the rear combustion chamber part 52B and includes heat conduction holes 80 formed therethrough. A heat conduction gap 82 is formed between the upper end 84 of the partition plate 78 and a top plate of the chamber defined by the inner liner 12A. The heat conduction holes 80 are opposed to the straight tube type burner 30.

The battery box 32 comprises a box body 84 with an underside opening 86, a bottom box cover 88 for closing opening 86 and a battery 90 arranged in the box body 84. The bottom plate 14 of the device box 24 is provided with a mounting hole 92. The box body 84 is inserted into the mounting hole 92 and fixed to the bottom plate 14 of the device box 24, and the box cover 88 is detachably fitted to the box body 84. The cover 88 is removable to allow for easy battery replacement.

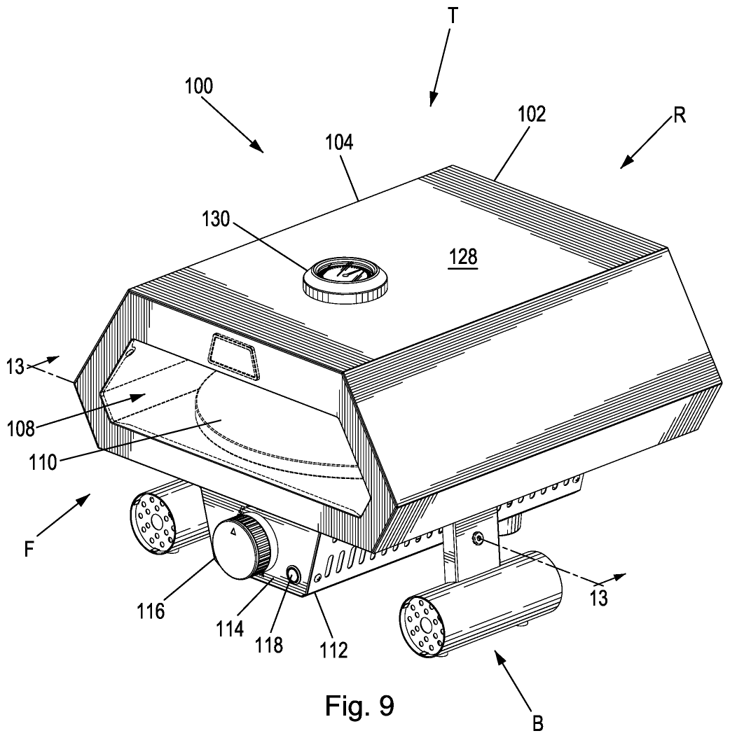

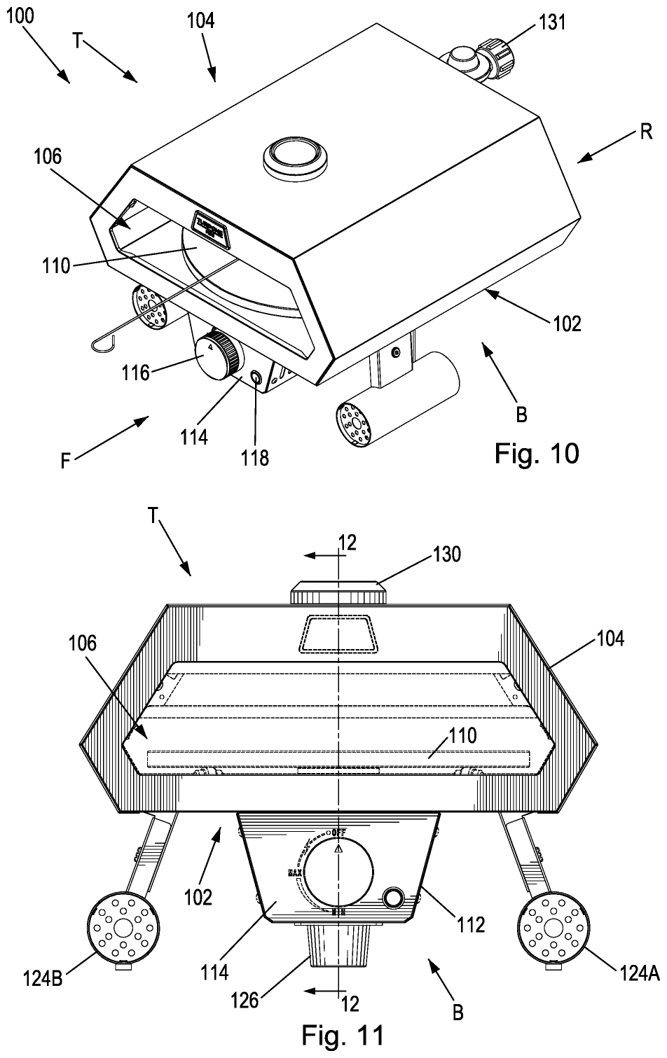

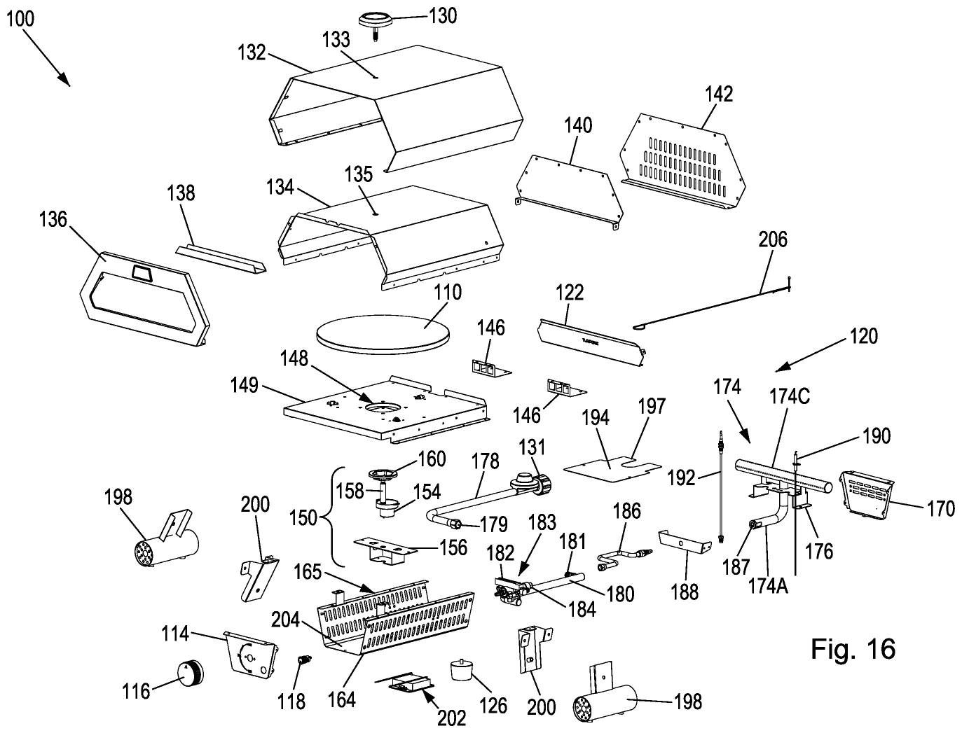

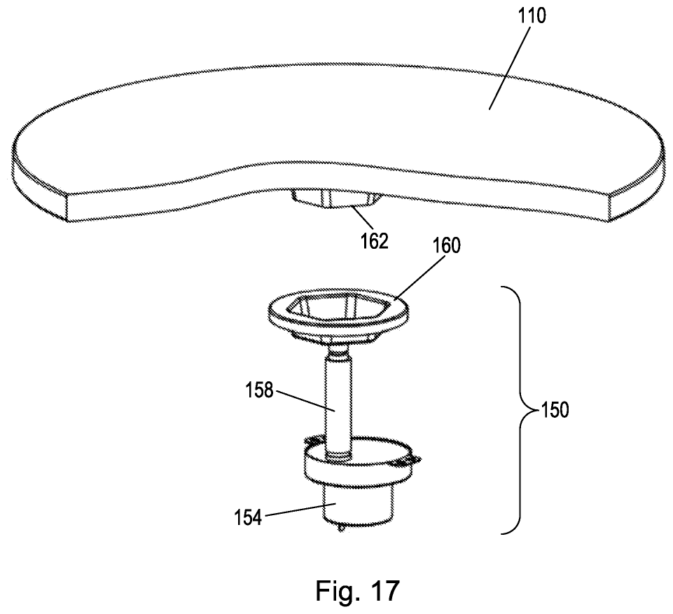

Turning now to FIGS. 9 to 17, there is shown a portable rotary pizza oven 100 in accordance with a non-limiting illustrative embodiment of the present disclosure which will be described by way of non-limiting examples.

With particular reference to FIGS. 9-13, the pizza oven 100 comprises a housing 102 defining a front side F and a rear side R, a top side T and a bottom side B. The housing 102 includes an upper casing 104 defining a front opening 106 leading to an internal chamber 108 including a rotating tray 110 for receiving and baking the pizza within the chamber 108. The housing includes a lower enclosure 112 connected beneath the casing 104. A control panel 114 is positioned at the front side F of the housing beneath and aligned with the opening 106. The control panel 114 includes a knob 116 for gas control and a click button 118 for actuating rotation of the tray 110. The chamber 108 defines a front baking chamber part 108A including the rotating tray 110 and a rear chamber part 108B including a heating assembly 120. A protection shield or fire plate 122 interposed between the chamber part 108A and 108B, thereby partitioning the chamber 108 and protecting the pizza from the flames of the heating assembly. The housing 102 is supported by legs 124A, 124B and 126. The top side 128 of the casing 104 includes a thermometer 130 for monitoring the cooking temperature. Gas is provided to the oven via a gas intake connector 131 which can be connected to a propane tank for example.

As will be further described herein, heat assembly components and tray rotation actuator components are positioned within the enclosure 112 allowing for the control panel 114 to be positioned at the front F of the oven 100 in line with the opening 106. The user can therefore modulate gas in tandem with looking at the flame produced by the heating assembly all the while monitoring the temperature. Having the components described herein beneath the casing 104 centers the weight of the oven 100 making it more portable and less lobsided regarding weight distribution. It is also safer to keep all controls at the oven opening as provided herein.

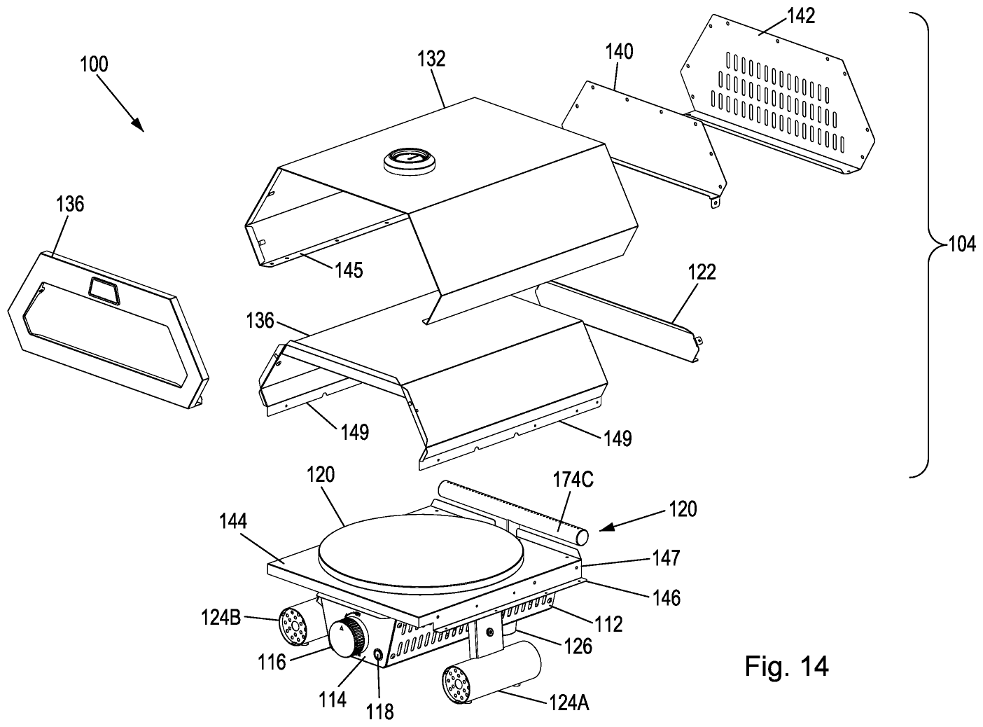

While still referring to FIGS. 9-13, and with particular reference to the various exploded views in FIGS. 14-17, the pizza oven 100 will be described in further detail.

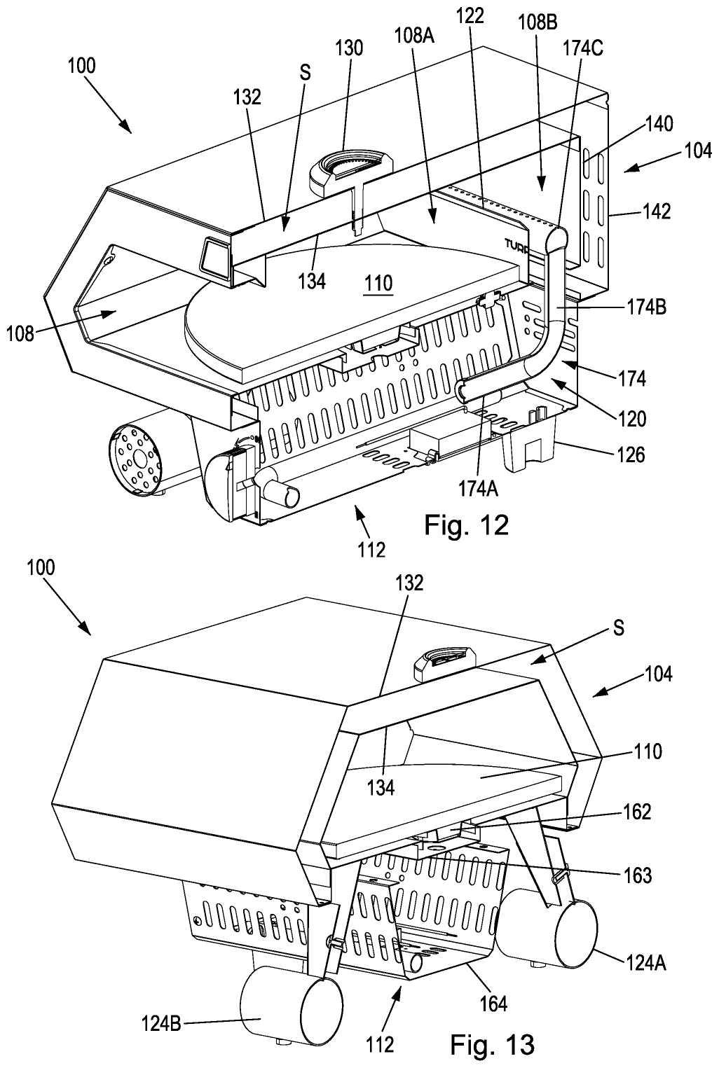

The casing 104 comprises shell structure mounted to a bottom plate. The shell structure comprises an outer shell 132 and inner shell or liner 134. The shells 132 and 134 are spaced apart and a foam insulation space S (see FIGS. 12 and 13) is provided therebetween thereby avoiding a user burning their hands when touching shell 132. A front door plank 136 closes the space between the shells 132 and 134. A baffle plate 138 is positioned on the inner side of the inner shell 134 behind the door plank 136 to redirect any flames inwardly of the chamber 108. The inner shell 134 is closed at the rear side R of the oven 100 by inner backing plate 140 and the outer shell 132 is closed at rear side R by the outer backing plate 142.

The shells 132 and 134 have respective and aligned apertures 133 and 135 for receiving the thermometer therethrough so that it can communicate with chamber part 108A for temperature monitoring.

The shells 132 and 134 are connected to a bottom plate 144 defining lateral wings 146. The later edges 145 of outer shell 132 are connected to the bottom plate 144 on the underside of lateral wings 146 and the lateral edges 150 of of inner shell 132 are connected to lateral sides 147 of the bottom plate 144.

The bottom plate 144 comprises a central hole or sleeve 148 for providing operative communication between the tray 110 and an actuator 150 which imparts a rotational movement to the tray 110. The tray 110 is a circular plate. In an embodiment, the circular plate 110 is a stone plate. The stone plate 110 rests on three bearings or rollers 152A, 152B and 152C radially disposed relative to the central sleeve for rollingly supporting the stone plate 110 thereon during rotation and preventing it from wobbling. The bearings 152A, 152B, 152C are slightly embedded within the bottom plate 144 and slightly protrude outwardly therefrom.

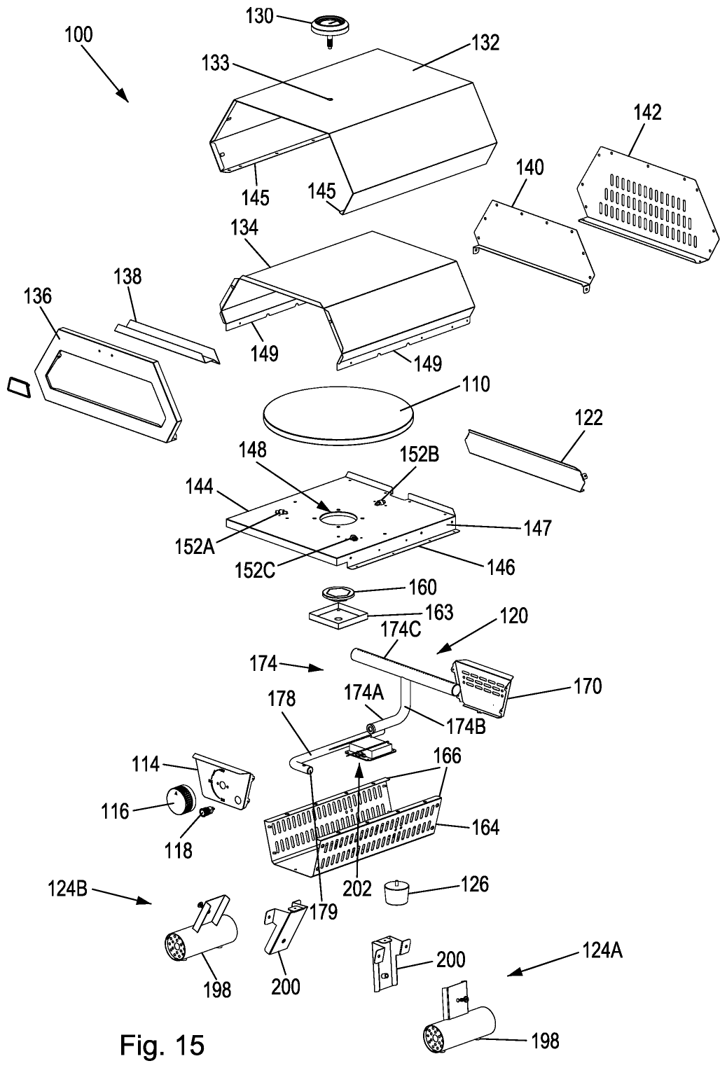

With particular reference to FIGS. 15 to 17, the actuator 150 comprises a motor 154 positioned within a support frame 156. A drive shaft 158 extends from the motor 154 and is connected to a seat support 160 which is positioned within the opening of the central sleeve 148 for receiving a seat 162 extending from the underside of the stone plate 110. The seat 162 is molded portion of the stone plate 110 and therefore is integral therewith. The seat 162 and the seat support 160 have corresponding hexagonal shapes. A protective panel 163 covers the portion of the seat support 160 downwardly extending from the bottom plate 144. The motor 154 causes the drive shaft 158 to rotate about its axis rotating therewith the seat support 162 with the seat 160 nested therein and thereby causing the stone plate 110 to rotate along the bearings 152A, 152B, 152C.

The enclosure 112 comprises a main frame body 164 having lateral edges 166 connected to the underside of the bottom plate 144. The motor 154 is positioned within the support frame 156 which is positioned within the enclosure 112. The drive shaft 158 protrudes from frame 156 to connect with the seat support 160 positioned within the opening of the sleeve 148. In this way, the motor 154, the drive shaft 158 and the center 168 of the stone plate 110 are vertically aligned for greater efficiency with the actuator 150 positioned directly beneath stone plate 110. The enclosure frame body 164 is closed at the front side F by the front panel 114 and at the rear side R by the rear backing panel 170.

The heating assembly 120 comprises a burner 174 in the form of a T-tube having an first horizontal tube part 174A connected via a vertical tube part 174B to a horizontal flame tube 174C that is positioned within the rear chamber part 108B and sits behind the partition or deflector shield 122 for heating the baking chamber part 108A. The T-tube burner 174 is maintained in place via a fixation frame 176 mounted on the bottom plate 144.

The heat assembly 120 comprises an air valve pipe 178 having the gas intake connector 131.

The air valve pipe 178 is connected at a front end 179 thereof to a rear end 181 of valve body 180 which is connected to a valve control 182 at its front end 183. The valve control 183 is controlled via the knob 116 to selectively allow gas to flow via a connector 184 into the injector 186 which is fluid communication with the front end 187 of the T-tube burner 174. The injector 186 is maintained in position via a holder plate 188. An ignition needle 190 is positioned in front of the horizontal burner tube 174C and provides for igniting the gas released thereby and a such producing the flame. A fail safe thermocouple 192 is also positioned in front the horizontal burner tube 174C. A heat shield 194 is mounted to the top open side 165 of the main frame body 164 of the enclosure 112 protecting the contents therein from the burner tube 174C when emitting heat. The heat shield has a notch 197 providing a clearance for tube part 174B.

The heating assembly 172 is positioned in chamber part 108B which is partitioned from chamber part 108A by the fire plate 122 which forms a top gap 123 with the inner shield 134 ceiling for heat to flow into the chamber part 108A.

The housing 102 may also include heat baffles 196.

Supporting legs 124A and 124B comprise respective feet 198 and leg extension 200 connected to the underside of the bottom plate 144.

A power source 202 is provided in the form of a battery pack mounted to the bottom part 204 of the enclosure 112 and housed therein to be in electrical communication with the actuator 150 so as to supply power thereto.

The oven 100 may also include an ignition rod 206.

The various features described herein can be combined in a variety of ways within the context of the present disclosure so as to provide still other embodiments. As such, the embodiments are not mutually exclusive. Indeed, the various features of pizza ovens 10 and 100 can be combined in a variety of suitable ways within the context of the disclosure. Moreover, the embodiments discussed herein need not include all of the features and elements illustrated and/or described and thus partial combinations of features can also be contemplated. Furthermore, embodiments with less features than those described can also be contemplated.

It is to be understood that the present disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been provided hereinabove by way of non-restrictive illustrative embodiments thereof, it can be modified, without departing from the scope, spirit and nature thereof and of the appended claims.

What is claimed is:

1. A pizza oven comprising:
a housing defining front, rear, top and bottom sides thereof and comprising:
an upper casing comprising a shell structure mounted to a bottom plate and defining an inner chamber therein and an opening at the front side providing access to the inner chamber; and
an enclosure positioned beneath the casing and mounted to the bottom plate at the bottom side and comprising a control panel at the front end beneath the front opening;
a rotatable tray rotatably mounted within the chamber for baking a pizza thereon, the rotatable tray defining a top side for receiving the pizza and an underside comprising a central seat rotatably positioned within an opening in the bottom plate;
an actuator mounted within the enclosure and comprising an upwardly extending drive shaft positioned beneath the seat and operatively communicating therewith for imparting a rotational movement to the rotatable tray;
a heating assembly mounted within the enclosure and comprising a heating part thereof extending into the chamber behind the rotatable tray for providing heat; and
controls provided on the control panel in operative communication with the actuator and the heating assembly for selective control thereof.

2. A pizza oven according to claim 1, further comprising support rollers protruding from the bottom plate to be engaged by the underside of the rotatable plate for stability thereof.

3. A pizza oven according to claim 1, wherein the housing further comprises an gas intake at the rear side in fluid communication with the heat assembly for providing gas thereto.

4. A pizza oven according to claim 1, wherein the enclosure is a longitudinal structure positioned along a central part of the bottom plate.

5. A pizza oven according to claim 1, wherein the rotatable tray and the seat are a single molded piece.

6. A pizza oven according to claim 1, wherein the actuator comprises a motor, the drive shaft upwardly extending from the motor.

7. A pizza oven according to claim 1, wherein the chamber defines a front chamber part and a rear chamber part partitioned by a fire plate therebetween, wherein the rotatable plate is positioned within the front chamber part and the heating part is positioned within the rear chamber part.

8. A pizza oven according to claim 1, wherein the heating part comprises a horizontal burner, a tube extends from the horizontal burner into the enclosure.

9. A pizza oven according to claim 1, wherein the shell structure comprises spaced apart outer and inner shells defining an insulation space therebetween.

10. A pizza oven according to claim 1, wherein the controls provide for controlling heat and rotation.

11. A pizza oven according to claim 1, further comprising support legs mounted to the housing at the bottom side.
